(19) United States
(12) Patent Application Publication
(10) Pub. No.: US 2026/0324555 A1
(43) Pub. Date: Oct. 22, 2026

(54) FRUIT HARVESTING DEVICE

(71) Applicant: MIRA S.R.L., CAVARENO (TN) (IT)

(72) Inventor: Marco FLAIM, CAVARENO (TN) (IT)

(21) Appl. No.: 19/101,467

(22) PCT Filed: Aug. 4, 2023
(86) PCT No.: PCT/IB2023/057893

§ 371 Date: Feb. 5, 2025

(30) Foreign Application Priority Data
Aug. 5, 2022 (IT) 102022000016863

(51) Int. Cl. A01D 46/26; A01D 46/253

(52) U.S. Cl. CPC A01D 46/264; A01D 46/253; A01D 2046/266

(57) ABSTRACT

The present invention relates to a device for harvesting fruit from a fruit plant.

The present invention relates to a device for harvesting fruits from the plant in which they are grown. In more detail, the invention relates to a device applicable to a fruit-picking machine, useful for carrying out the detachment of fruits from the relative plants to which they are joined, an operation that can be carried out conveniently and quickly, and at the same time simply.

The invention is described below when used in apple picking, but it is clear that the device that is the subject of the invention can also be applied when other fruits are to be picked.

Apple picking is usually done manually. In order to facilitate harvesting personnel, the known technique also involves the use of machines on which operators are arranged, possibly at different heights, so as to advance along the row as the machine moves.

However, the operators still manually detach the apple from the tree and place it directly on a collection box or on a belt that carries the apple to the appropriate collection box.

In an effort to automate these operations, equipment has emerged in recent years to replace the operator.

This equipment usually involves two important systems that cooperate with each other:
a vision system designed to recognize the fruit to be harvested;
a system for picking and detaching the fruit from the plant.

In the case of the vision system, these are common optical devices, cooperating with a computing and control unit. They are responsible not only for recognizing the fruit, but also for identifying its position in space according to the three Cartesian coordinates.

In the case of the grasping and detaching system, the known technique presents various types of devices.

For example, anthropomorphic devices are known, specifically mechanical articulated arms with ends equipped with grasping fingers.

Such arms bring their ends adjacent to the fruit to be picked. The fingers grasp the fruit and rotate it to make it detach from the plant.

Finally, while maintaining the grip on the fruit, the mechanical arm is moved to bring the apple to the appropriate picking box.

Then there are gripping systems comprising an articulated tube whose end port is brought adjacent to the fruit to be picked. By means of vacuum creation, the tube sucks in the fruit, which is carried, again through the tube, to the collection box.

There are several problems inherent in such equipment.

First, they are complex equipment with a high level of technology; consequently, breakages and malfunctions can be the order of the day.

Moreover, their set-up, depending on the fruit to be harvested and the type and age of the row crop, is also time-consuming.

As for vision systems, they may not detect apples hidden by leaves or branches.

Relative, on the other hand, to picking and detaching systems, they have a speed that is not so fast, making picking operations time-consuming.

This problem, yes, can be solved by using multiple devices, but they may get in the way of each other.

It is the purpose of the present invention to overcome the problems highlighted above and others.

In particular, it is the purpose of the present invention to provide a harvesting device for performing fruit picking automatically.

Another purpose of the present invention is to provide a fruit harvesting device that is nonetheless simple so as not to require special maintenance.

A further purpose of the present invention is to provide a fruit-harvesting device that does not require special adjustments, so as to operate quickly in both the set-up and harvesting phases.

These and other purposes are achieved by a fruit-harvesting device, applicable to a harvesting vehicle capable of moving along a row of fruit plants, characterized by comprising a stand to which at least one fruit support structure is attached. Such support structure comprises sticks suitable for inserting between the plants of the row, inferior to the fruits so as to support them, when they are detached from the respective plant.

The sticks, while flexible, have enough rigidity to support the fruits superiorly, preventing them from falling.

In addition, the sticks, due to their conformation, fit into the plant itself, going to cover even the most hidden areas.

Advantageously, the harvesting device may comprise at least one bulkhead suitable for leading the fruits from the one or more support structures to a harvesting device, such as may be a conveyor belt, harvesting crate, or other means of collecting and containing the fruits.

In addition, the harvesting device may include a wall suitable for preventing fruit from falling.

Advantageously, means of separating fruits from plants suitable for carrying such fruits onto the one or more support structures may be included.

Such separation means, such as, for example, anthropomorphic or other systems with similar function, may be connected to an artificial intelligence system and/or an intelligent vision system so as to select fruits to be detached from the plants.

Advantageously, the means of separation may include means of swinging said sticks so that said sticks are moved in a vertical direction and can go to solicit the fruits that are thus detached from the respective plant.

In addition, the means of separation may include vibratory devices suitable for selectively shaking the plants or gripping devices suitable for selectively grasping the fruits.

Advantageously, bristles suitable for cushioning the blows of the fruits on the sticks themselves may be included between said sticks.

In addition, the support can be movable so as to move the support structure relative to the plants in the row.

Advantageously, the support may comprise a rotating tubular element to which is attached at least one spoke element comprising sticks arranged in a radial pattern and bound to the tubular element.

In this way, the spoke element fits into the plant and, depending on the rotational speed of the support and the speed of the vehicle, remains substantially integral to the plants.

Multiple spoke elements are mounted on the tubular element so that the fruits do not fall downward, but are instead supported by the nearest spoke element.

In addition, the support may include a first driving drum and a second idler drum around which a belt is arranged to which sticks are attached.

An elongated structure is thus created, which can thus be arranged along several adjacent plants.

The support may comprise a moving belt moved by at least three drums, at least two collecting structures each comprising a support connecting to the moving belt, and sticks attached to that support, being attached to the moving belt.

The harvesting structures thus have the configuration of a hand being inserted into the plant to support fruits that are detached from the same plant.

Further features and advantages of the present invention will become clearer from the description of some examples of implementation as illustrated in the attached figures in which:

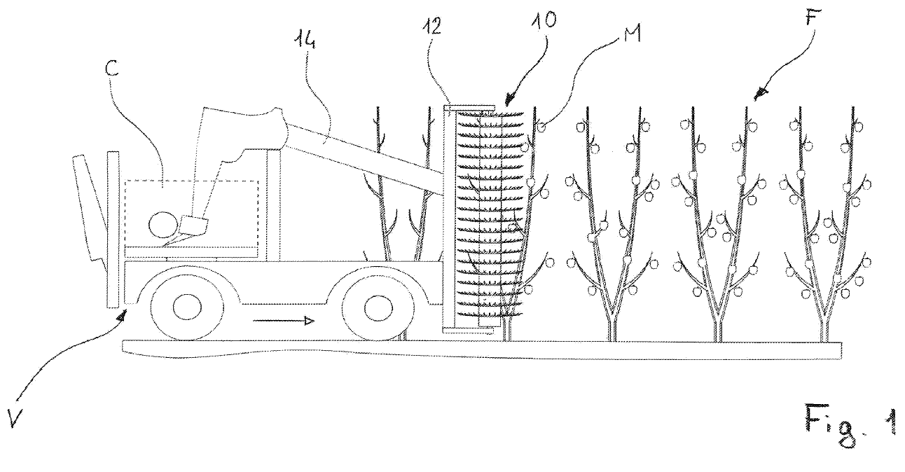

FIG. 1 is a schematic representation of a harvesting machine including a harvesting device according to the invention;

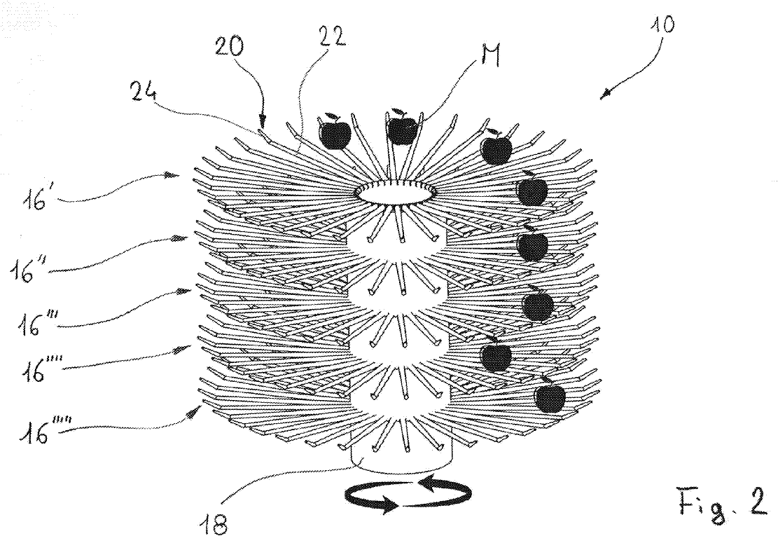

FIG. 2 is a schematic axonometric view of a collecting device according to a first embodiment of the invention;

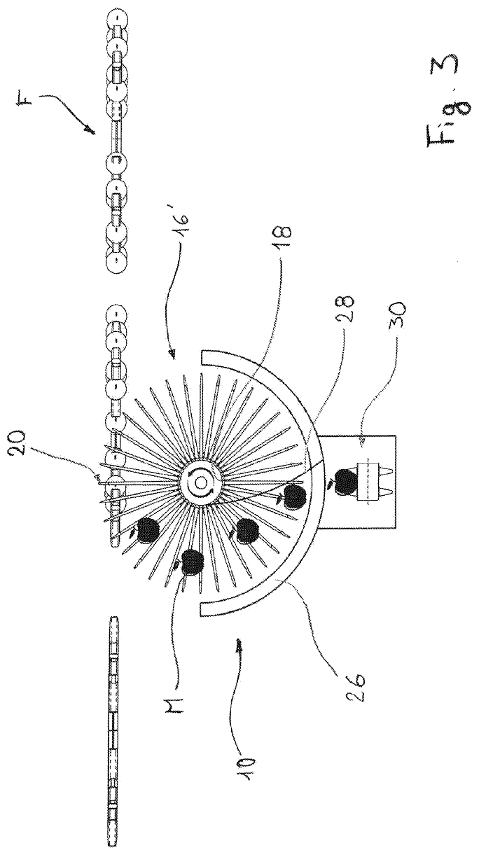

FIG. 3 is a schematic top view of a collecting device according to the first embodiment mode when operative;

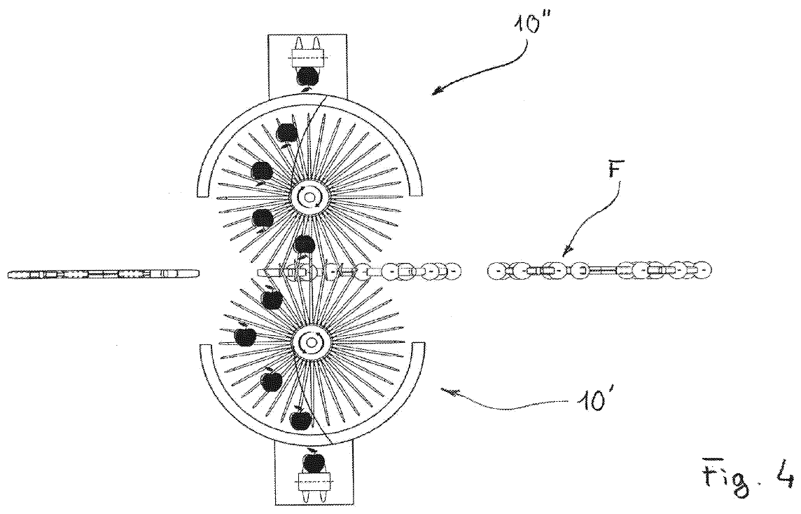

FIG. 4 is a schematic top view of two harvesting devices according to the first embodiment mode, arranged in opposite positions on a row;

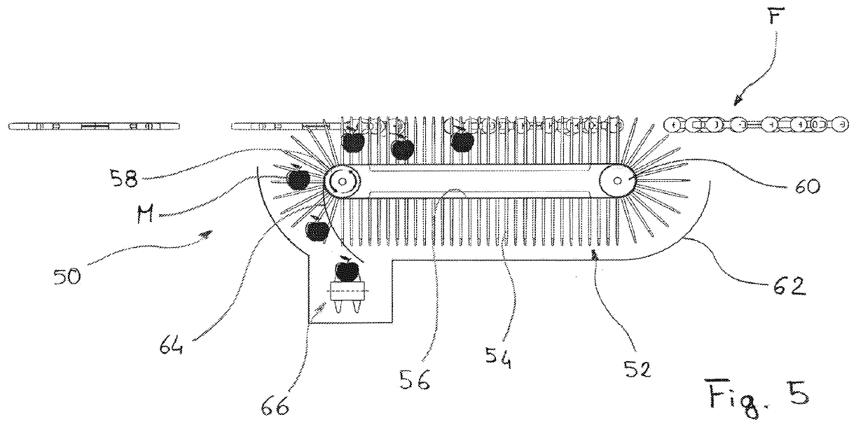

FIG. 5 is a schematic top view of a collection device according to a second embodiment mode of the invention, when operational;

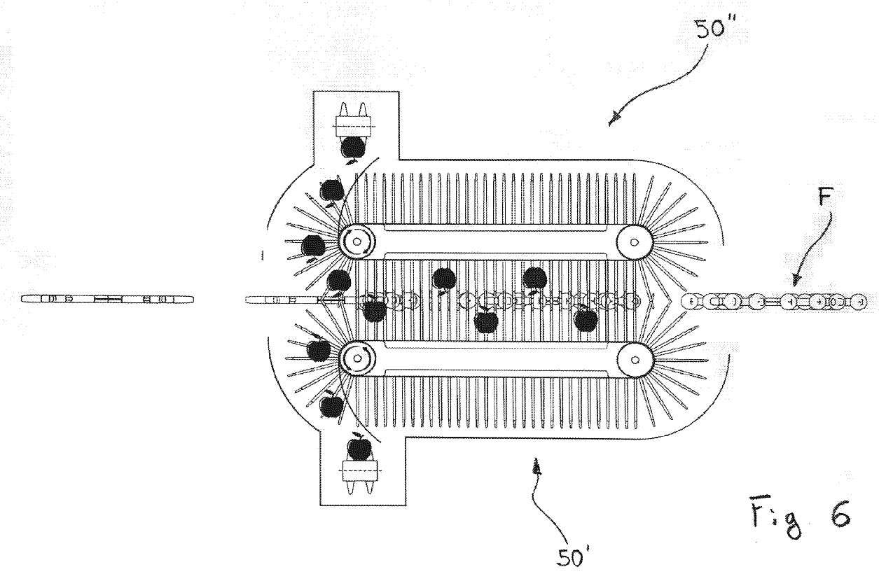

FIG. 6 is a schematic top view of two collecting devices according to the second embodiment mode of the invention, arranged in opposite positions on a row;

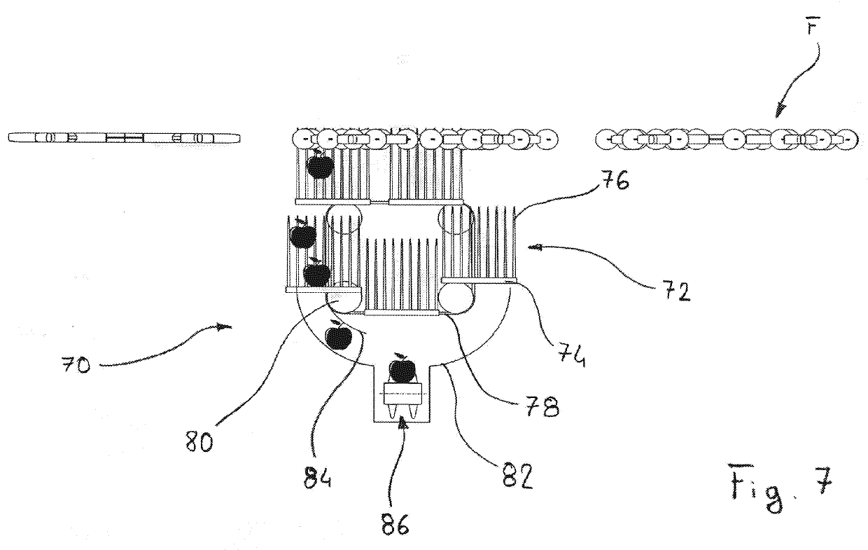

FIG. 7 is a schematic top view of a collection device according to a third embodiment mode of the invention, when operational;

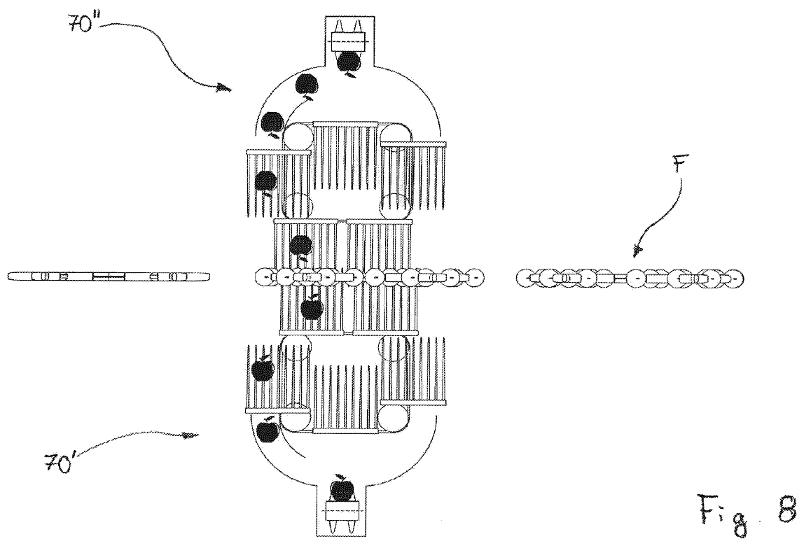

FIG. 8 is a schematic top view of two collecting devices according to the third embodiment mode, arranged in opposite positions on a row.

With reference to the attached figures, particularly FIGS. 1 through 3, an apple harvesting device is indicated by the number 10.

The apple-harvesting device 10 is attached by means of supporting means 12 to a harvesting vehicle V moving along a row F of apple trees M (only one shown in FIG. 1).

Specifically, as shown in FIG. 1, the harvesting device 10 can retrieve apples M from the apple trees M by unloading them onto a conveyor belt 14 or similar device that carries them inside a bin C arranged on the harvesting vehicle V.

The collection device 10 comprises multiple spoke elements 16′, 16″, 16″, 16″″, 16′″″ attached to a vertical rotating tubular element 18.

Each spoke element 16″, 16″, 16″, 16″″, 16′″″ comprises sticks 20 (only one shown in FIG. 2) arranged in a radial pattern and constrained to tubular element 18.

Each stick 20, made of elastic material, comprises a main portion 22 connected to the tubular element 18 and an outer portion 24 bent slightly upward from the main portion 22 to which it is joined as a single body.

As per FIG. 3, the collection device 10 further comprises an arched wall 26 arranged at the outermost portion of the same collection device 10 relative to the row F, so as to prevent apples M from falling outwardly.

In addition, the harvesting device 10 includes a bulkhead 28 apt to compulsorily guide apples M lying on the spoke element 16′ toward a vertical conveyor belt 30.

Specifically, as visible in FIG. 3, harvesting device 10 is arranged adjacent to row F so that a portion of the spoke elements 16′ fits into row F.

Specifically, the outer portions 24 of some sticks 20 fit inside the F row itself, sandwiching between the M apples, as also visible in FIG. 1.

Harvesting device 10 is also advanced along row F and simultaneously rotated, so that each stick 20 that fits into row F remains stationary relative to the portion of row F into which it has inserted itself.

Each apple M in row F that is detached from the plant can rest on the spoke element 16′ arranged just below the same apple M.

The slightly upward sloping outer portion 24 prevents unwanted dropping of the M apples to the outside of the spoke element 16′, together with also the arched wall 26.

The continuous rotational movement of the spoke elements 16′ causes the apples to continue to rotate around the tubular element 18 until they meet the bulkhead 28 that forces them to take to the conveyor belt 30.

The M apples can be detached from the tree by appropriate means of separating the M apple from the related plant.

Such means of separation may be:
1. of vibratory devices suitable for selectively shaking the apple plants into which the spoke elements 16′ have been inserted;
2. gripping devices suitable for grasping each M apple and rotating it so that it is detached from the plant and left on the nearest 16′ spoke element.

Alternatively, in order to effect the detachment of each M-apple from its plant, each stick 20 can move in a vertical direction, rising and falling, i.e., swinging, so as to gently shake the M-apples and make them detach from the plant.

Such movement of the sticks 20 can be accomplished by a cam mechanism, assisted by the rotary motion of the spoke elements 16′, or by actuators that move the sticks 20 (individually or together), or by other mechanisms.

The movement of the sticks 20 can be carried out by mechanisms operated by an artificial intelligence system, assisted by an intelligent vision system.

Thanks to such a system, only the desired sticks can be placed in motion, so that only the chosen fruits are detached from the plant and thus a selection is made.

The harvesting device 10 according to the invention and as just described, can be arranged on either side of a row F, as shown in FIG. 4.

A first harvesting device 10′ and a second harvesting device 10″ are arranged on each of the two sides of the row F. In this way, total harvesting of apples is ensured and, in particular, the fall of apples from the opposite side is prevented as compared with the placement of only one harvesting device 10.

According to a first variant of the invention, shown in FIG. 5, a harvesting device 50 comprises rotating structures 52 mounted at different heights.

In FIG. 5, only one rotatable structure 52 is visible, but similar to what is depicted in FIGS. 1 and 2 for the collection device 10, the collection device 50 illustrated herein also includes multiple rotatable structures 52 stacked on top of each other.

Each revolving structure 52 includes sticks 54 constrained to a revolving belt 56 set in motion by a first driving drum 58 and a second idler drum 60.

In addition, the harvesting device 50 includes a wall 62 arranged on the side not affected by the row F, and a bulkhead 64 that forces the M apples to move toward a harvesting belt 66.

Similar to harvesting device 10 previously described and illustrated in FIG. 4, harvesting device 50 can also be arranged on both sides of a row F, as shown in FIG. 6.

Again, a first harvesting device 50′ and a second harvesting device 50′ are arranged on each of the two sides of row F. A safer and more complete apple harvesting is thus ensured, and in particular, the falling of apples from the opposite side is prevented compared with only harvesting device 50 in FIG. 5.

According to a second variant of the invention, as illustrated in FIG. 7, a harvesting device 70 comprises five harvesting structures 72, each comprising a support 74 to which sticks 76 are attached parallel to each other.

Each support 74 is attached to a moving belt 78 moved by four drums 80 (only one shown in the figures).

In addition, the harvesting device 70 includes a wall 82 arranged on the side not affected by the row F, and a bulkhead 84 that forces the M apples to move toward a harvesting belt 86.

Similar to harvesting device 10 and harvesting device 50 previously described and illustrated in FIG. 4 and FIG. 6, respectively, harvesting device 70 can also be arranged on both sides of a row F, as shown in FIG. 8.

Again, a first collection device 70′ and a second collection device 70′ are arranged on each of the two sides of the F row.

The invention has been described for illustrative and non-limiting purposes, according to some preferred forms of implementation. Numerous other forms of implementation and variations may be found by the skilled engineer in the field, all of which fall within the scope of protection of the following claims.

Each stick can be made by the combination of several bristles, so as to ensure sufficient support and at the same time flexibility and elasticity.

In addition, in order to avoid unwanted bumps between the individual sticks, brushes with bristles of elastic and flexible material may be arranged.

Such bristles can be arranged in the inner part of 16′ spoke elements or distributed in height between 16′ spoke elements.

In addition, the sticks can be made by means of tubes whose rigidity is controlled by pneumatic or hydraulic controls, so that these tubes can be flexed according to the needs of the moment, such as by control with vision systems.

1.-12. (canceled)

13. Harvesting device of fruits M, applicable to a harvesting vehicle V capable of moving along a row F of fruit plants M, said harvesting device comprising a support to which at least one support structure of the fruits M; said at least one support structure comprising sticks; said sticks being suitable for being inserted between the plants of the row F below the fruits M so as to support said fruits M.

14. Harvesting device according to claim 13, wherein at least one bulkhead is comprised, said bulkhead is adapted to lead the fruits M from the at least one support structure into a harvesting device.

15. Harvesting device according to claim 14, wherein is included a wall adapted to prevent fruits M from falling from the at least one support structure.

16. Harvesting device according to claim 13, wherein separating means for separating the fruits M from the plants to the at least one support structure are included.

17. Harvesting device according to claim 16, wherein the separating means are connected to an artificial intelligence system and/or an intelligent vision system so as to select the fruits M to be detached from the plants.

18. Harvesting device according to claim 16, wherein the separating means comprise means for swinging said sticks so that said sticks are moved in a vertical direction.

19. Harvesting device according to any one of claims 16, wherein the separating means comprise vibratory devices for selectively shaking the plants or gripping devices for selectively grasping the fruits M.

20. Harvesting device according to claim 13, wherein said sticks comprise bristles.

21. Harvesting device according to claim 13, wherein the support is movable so as to move the support structure with respect to the plants of the row F.

22. Harvesting device according to claim 13, wherein the support comprises a rotatable tubular element to which is attached at least one radiating element comprising sticks arranged in a radial pattern and constrained to the tubular element.

23. Harvesting device according to claim 13, wherein the support comprises a first driving drum and a second idler drum around which is arranged a belt to which sticks are attached.

24. Harvesting device according to claim 13, wherein the support comprises a movable belt moved by at least three drums, at least two collection structures each comprising a support connecting to the movable belt, and sticks attached to said support.

25. Harvesting device according to claim 20, wherein the support comprises a rotatable tubular element to which is attached at least one radiating element comprising sticks arranged in a radial pattern and constrained to the tubular element.

26. Harvesting device according to claim 20, wherein the support comprises a first driving drum and a second idler drum around which is arranged a belt to which sticks are attached.

27. Harvesting device according to claim 20, wherein the support comprises a movable belt moved by at least three drums, at least two collection structures each comprising a support connecting to the movable belt, and sticks attached to said support.
